(19) United States
(12) Patent Application Publication
(10) Pub. No.: US 2007/0005996 A1
(43) Pub. Date: Jan. 4, 2007

(54) Collecting thermal, acoustic or power data about a computing platform and deriving characterization data for use by a driver

(76) Inventors: Rajeev K. Nalawadi, Folsom, CA (US); Anil Kulkarni, Bangalore (IN); Vijay Anand Purushothaman, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,500

(22) Filed: Jun. 30, 2005

(51) Int. Cl. G06F 1/26

(52) U.S. Cl. 713/300

(57) ABSTRACT

Thermal, acoustic, and/or power data is collected about a platform, in its runtime environment. A component of the platform is selected, and predetermined data traffic is forced through the component while collecting the data. Characterization data for the platform is derived, from the collected data, and stored for access by a driver for the platform. Other embodiments are also described and claimed.

An embodiment of the invention is directed to collecting thermal, acoustic or power data about a computing platform in a traffic controlled runtime environment, and using the collected data for managing thermal effects, acoustic effects, or power consumption. Other embodiments are also described.

### BACKGROUND

A computing platform (or simply, platform) is the underlying hardware and/or software for a system. For example, the platform may be a Pentium® processor by Intel Corp., Santa Clara, Calif., and its related integrated circuit I/O components and I/O interconnect running a compatible operating system. The platform may define a popular specification around which a system can be developed and manufactured, by an original equipment manufacturer (OEM) such as Dell, Inc. Round Rock, Tex. Once a platform has been defined, software developers can produce appropriate application programs that can run on different systems which are based on the same platform.

There are several different types of platforms. For example, there are platforms for desktop computers, such as those that feature a Pentium® processor and a compatible operating system. Another is a notebook/laptop computer platform (e.g., one that has a Centrino™ processor also by Intel Corp.) Yet another may be a handheld computer platform such as one that has an XScale or StrongARM processor and an embedded operating system.

Since there is continued demand for small form factor platforms, such as ultra-sleek laptops, handhelds, and mobile assistants, there is a desire in the industry to include more functionality in the individual systems that are based on such platforms. Allowing more functionality and components within the platform, however, raises the issue of how to manage, from an overall, system point of view, power consumption and thermal effects in the system. These issues include, for example, how to make a rechargeable battery that powers the system last longer, or how to operate the system so as to avoid hot spots that may degrade the hardware components of the system or reduce overall performance and the desirability of the product. Indeed, many modern, high performance, portable computing systems become quite hot during operation, and uncomfortable for a person to hold for a long period of time. These issues are exacerbated in situations where the platform provides insufficient space for a fan or active cooling system, such that all cooling may need to be performed using passive techniques (e.g., strategically placed heat sinks, or emergency shutdowns of an overheating component in the system).

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a diagram of a method for collecting thermal, acoustic or power data about a platform and deriving characterization data for the platform, according to an embodiment of the invention.

FIG. 2 is a diagram of multiple drivers for different hardware components of a system, according to an embodiment of the invention.

FIG. 3 is a block diagram of a computer system whose drivers may be in accordance with an embodiment of the invention.

FIG. 4 shows some of the component blocks involved in an example, dynamic, thermal characterization of a system.

FIG. 5 is a flow chart indicating a timer-based technique for collecting data in a driver, according to an embodiment of the invention.

### DETAILED DESCRIPTION

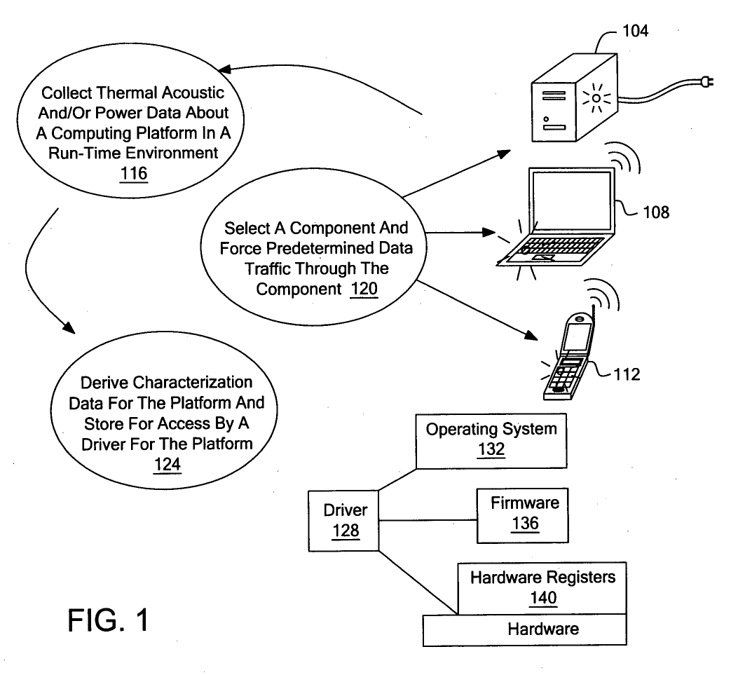

FIG. 1 is a diagram of a method for collecting thermal, acoustic and/or power (TAP) data about a platform, and deriving characterization data based on dynamic algorithmic computations for the platform, according to an embodiment of the invention. The method may apply to any number of different types of platforms and systems. Some examples include: a server or desktop computer system 104; a notebook/laptop personal computer 108; and a handheld, wireless email device 112. The latter are, of course, examples of portable computing devices that have within their housing or chassis a rechargeable, power source that is coupled to power the processor and memory of the system. Each of these systems may be an instance of, or is said to be based on, a different platform. Each of these systems and platforms exhibits very different, thermal, acoustic and/or power consumption effects, in their runtime environments. The term “runtime environment” refers to a situation where a system has one or more processors that are operating in a normal, active mode, running an operating system program 132, and optionally an application program, or that are operating in a power saving mode (e.g., stop clock throttle mode; sleep mode). These are in contrast to a special test mode that the system might be temporarily placed in, for example, by its OEM during an OEM manufacturing stage. The runtime environment may be either at an OEM stage for the system, or at an end user stage (where an end user or consumer has purchased or leased the system and is operating it as intended).

The method calls for collecting TAP data about the computing platform, in its traffic controlled runtime environment (operation 116). This data may be raw measurements of temperature, acoustic level, and/or power consumption. The thermal data may include a temperature reading made by a temperature sensor that is strategically located within the system. The temperature sensor may be integrated with a component of the platform, such as an integrated circuit (IC) device or functional block, a packaged IC device, or a heat sink. The sensor may alternatively be designed and located so as to obtain an ambient temperature inside the housing of the system. Power consumption may also be measured, for example, on a per component basis by strategically placed resistors between a DC power source and a voltage rail of the component, or for the overall system as a whole (e.g., detecting the voltage and current of a rechargeable power source). The acoustic data may be measurements of audible sound levels, such as the audible fan noise or rotating disk drive noise, made, for instance, by sampling the audio data captured by microphones integrated within the system and using an integrated, high definition audio (HDA) controller for sampling sound waves at a predetermined frequency.

While the TAP data is being collected, a component of the system may be selected and predetermined data traffic is then forced through it (operation 120). This component may be an integrated circuit device or a functional unit thereof, a packaged IC device, or an entire subsystem. Examples include a graphics processing component (e.g., a display controller), a mass storage component, a peripheral I/O controller component (e.g., a universal serial bus, USB, host controller), a network interface component (e.g., a wireless network interface controller, WNIC), and a main memory component (e.g., dynamic random access memory, DRAM, subsystem).

The predetermined data traffic that is forced through a component may be designed to stress the component, such that the component will consume more power and dissipate more heat as a result. For example, if the component relates to main memory, a relatively complex data pattern or file may be written to main memory, changed, and then read back, with this process repeated multiple times over a short period of time. To stress a graphics processing component, certain specialized, graphics application programming interface (API) calls may be made (e.g., DirectX, DX8 and DX9 calls). For a peripheral I/O component, the stresser may be in the form of generating a relatively high rate of data traffic on one or more of its I/O ports. For a storage controller, a stream of numerous small transactions, or a few large ones, with predetermined content, may be requested to write or read the mass storage in rapid sequence. Note that this capability for injecting controlled traffic into the platform should be available at varying levels, so as to provide a wide range of stresses.

Based on the collected data and in view of the injected, controlled traffic environment, characterization data for the platform is derived using algorithmic calculations, and stored for access by a driver 128 for the platform (operation 124). The driver 128 is a program that, in a layer sense, fits between the operating system and system firmware 136. The driver may access the operating system, firmware, and the hardware registers 140 of the system hardware. The driver 128 is to access the stored characterization data, for managing thermal effects, acoustic effects, and/or power consumption in a system that is based on the platform.

The characterization data describes data traffic-related, thermal and/or power changes in the platform. The data may specify how the temperature of a particular component changes, in response to inducing certain data traffic into that component or into a neighboring component. The characterization data may also provide an action list for a certain thermal reading, where the action list makes several suggestions for how to deal with, for example, an elevated temperature in a particular component (e.g., reduce a clock rate on a particular port, throttle the component, reduce the clock rate in a neighboring component, or other mechanism, in an attempt to avoid a catastrophic shutdown of the overheating component). Such characterization data may be derived by the OEM, at a manufacturer stage, by evaluating several instances of a system that is based on a platform. The same methodology may be applied to several different platforms used by the OEM, if the design parameters of their respective systems are essentially the same. The data may then be saved in a database to be later accessed by a driver for the platform, to manage thermal, acoustic, and/or power issues in a runtime environment of a system that is based on one of the platforms.

Advantageously, the driver may access the database and manage the system in which it is running, at an end user stage, and transparently to an end user and without notifying an application. The driver may access the data to keep temperature and/or power consumption in its system under control. For example, certain operating parameters of the system, such as an I/O port clock rate, may be reduced by command of the driver, in the runtime environment, and without requiring input from a user of the system.

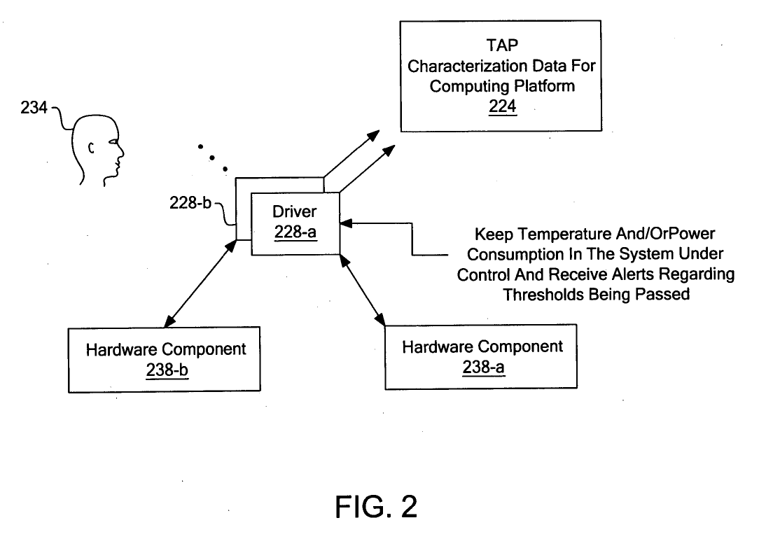

According to another embodiment of the invention, referring now to FIG. 2, a system has several drivers 228_{—}a, 228_{—}b, . . . , (such as the one described above) that are in the runtime environment, where each driver is for a different hardware component 238_{—}a, 238_{—}b, . . . of the system. Each driver 228 is to access stored, TAP characterization data 224 for the platform on which the system is based, and to use the accessed data to kept temperature and/or power consumption in the system under control. In this case, each driver 228 is to access the hardware registers of its particular component and not others, e.g. to obtain a temperature measurement made by a thermal sensor for that component. Each driver 228 may also receive and respond to an alert (e.g., via an interrupt mechanism) that a temperature of its associated component 238 has passed a programmed temperature threshold. One or more of such drivers may also use an advanced configuration power interface (ACPI), to access the hardware registers of its associated component. Each driver may also be able to program clock throttling values and/or thermal sensor temperature thresholds for its respective hardware component. In addition, each driver may be able to enumerate the usable throttle modes of its component. There may be a driver for a graphics processing component, another driver for a mass storage component, another for the peripheral I/O controller component, and still another for a network interface component. In the case of certain Pentium® processor platforms, there may be two such drivers, one for a graphics memory controller hub (GMCH), and another for an I/O controller hub (ICH) of the platform.

In a further embodiment of the invention, each driver may be able to obtain thermal readings, access the stored characterization data for the platform, and make adjustments to the operating parameters of its associated component, independently of the other drivers' actions. In other words, the drivers need not communicate with each other, or necessarily be aware of each other's thermal management actions.

In yet another embodiment of the invention, each driver 228 may automatically access the stored, thermal characterization data, and make adjustments to the operating parameters of its associated component, transparently to a user, at the end user stage. In other words, the driver need not be commanded by the user or by higher layer software, to make the adjustments. In the runtime environment, the driver may, for example, obtain some thermal reading from a component, and may then look up the thermal reading in the characterization database, and will be presented with the action list which includes one or more suggestions for managing the thermal situation. These may include, for example, increasing a clock rate if the thermal reading suggests that sufficient heat has been dissipated, or reducing a clock rate on a particular port if the reading indicates that the component is cooling down.

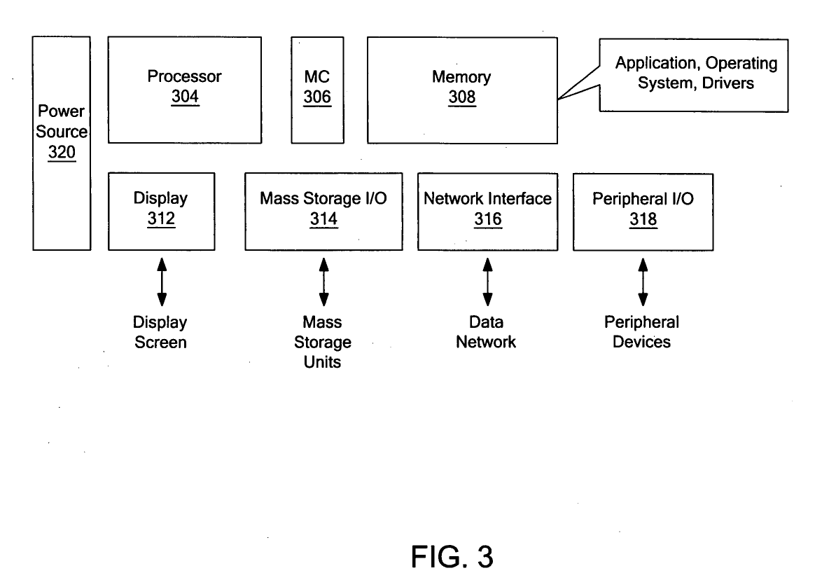

Turning now to FIG. 3, a block diagram of a system whose drivers may be in accordance with an embodiment of the invention are shown. This is an example of a laptop/notebook platform that features a processor 304, a memory 308 to store the drivers, operating system, and application, and a memory controller 306. All three components may be integrated on the same integrated circuit die, in the same packaged IC device, or in different IC packages. The system also has a number of other integrated circuit components including a display controller 312 (coupled to a display screen), a mass storage I/O controller 314 (to be coupled to one or more mass storage units), a network interface 316 (to be coupled to a data network), and a peripheral I/O controller 318 (to be coupled to external, peripheral devices). A rechargeable power source 320 (e.g., a rechargeable nickel metal hydride battery) is coupled to power the processor, memory, as well as all of the other illustrated circuit components of the system. The driver in this instance is able to both collect thermal data about the platform on which the system is based (in a runtime environment), and automatically access stored, thermal characterization data about the platform to manage the particular system in which it is operating. An example is a device driver that may be authored by a manufacturer of the display controller 312, the storage I/O controller 314, the network interface 316, or the peripheral I/O controller 318. This device driver may be a separate piece of software that is in addition to a conventional device driver. The conventional device driver is typically installed in a system along with or as part of an operating system program and is necessary for the operating system to generally access the corresponding hardware component.

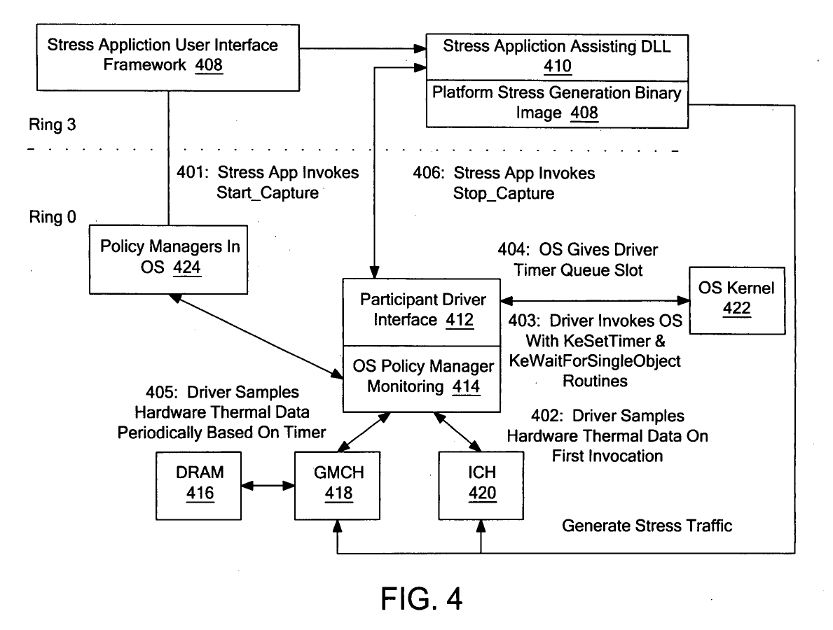

Turning now to FIG. 4, some of the component blocks involved in TAP data collection in a system are shown, according to another embodiment of the invention. This diagram focuses on the driver data collection aspect of the methodology, as compared to the driver thermal management aspect. The situation in FIG. 4 involves an application program that induces controlled data traffic into its system, in the runtime environment, while collecting the TAP data. The application may also be referred to as a stress tool or an intelligent virus tool, because it is designed to cause certain aspects of the system to be overworked intentionally, and under predetermined and controlled conditions, for a desired goal of obtaining characterization data (to be used for managing TAP in the platform). The application may be provided to the system OEM, together with the drivers, by a manufacturer of any one of the integrated circuit components.

The components of the system shown in FIG. 4 include a stress application user interface framework 408 which may be software that provides a user (e.g., at the OEM stage) with a graphical user interface that allows the user to enter her desired selections for collecting TAP data, and interpreting or displaying the resulting characterization data. In this example, the framework 408 is at “Ring 3”, namely somewhere above the operating system layer (e.g., application layer) and above “Ring 0” which refers to the kernel layer of the operating system.

The user interface framework 408 may communicate with a stress application assisting dynamic link library (DLL) 410 that provides programming for the functions that display the collected data or control which components of the system are to be stressed. One or more platform stress generation binary images 408 are also provided, in this example at Ring 3, to generate the needed data patterns for stressing the various components of the system. The stress application may apply the binary image to generate stress traffic in any one of a number of hardware components of the system, including, for example, the ICH 420, GMCH 418, or DRAM 416. The stress traffic may be applied to the components, one component at a time. That is because thermal effects likely exhibit linear behavior, so that stressing components one at a time and using a linear combination of the collected data provides more flexibility in determining characterization data.

The stress application communicates with policy managers 424 that are in the operating system, where the policy managers 424 report to the application the occurrence of thermal events such as overheating, or power consumption events such as a voltage of a rechargeable battery of the system being too low. The policy managers 424 may themselves respond to such events by, for example, shutting down certain components of the system to avoid overheating or to avoid catastrophic failure (e.g., shutdown a display screen, write the contents of memory to non-volatile mass storage, prior to shutting down the entire system, etc.)

In this embodiment, the application collects the TAP data through the use of the driver, and in particular by invoking the functions of a participant driver interface 412. The participant driver interface 412 in turn may invoke an interface of an operating system kernel 422, to achieve its data collection mission. The participant driver interface 412 may also be assisted by conventional, operating system policy manager monitor 414, for purposes of monitoring certain hardware events. The participant driver interface may become part of, for example, the API of an operating system such as Mircosoft™ Windows.

FIG. 4 also depicts an example process of thermal data collection, according to an embodiment of the invention. Operation begins with the stress application invoking a start_capture function of the participant driver interface 412, in response to which the driver begins to sample thermal data about its associated hardware components (operation 402). In addition to thermal data, the driver may also sample, for example, the values of counters (that are provided within the hardware layer), for reporting the flow of traffic through various subsystems (e.g., X megabytes per second flowing through Peripheral Component Interconnect (PCI) Express port number Y). Since in this example instance, the driver which is written for a Microsoft operating system is to read thermal data periodically, operation 403 calls for the driver to invoke the operating system with conventional function calls of KeSetTimer and KeWaitForSignalObject routines. This allows the driver to use existing timer capabilities of the operating system. The operating system thus gives the driver a timer queue slot (operation 404), and periodically alerts the driver every time the timer times out. In operation 405, the driver samples the thermal data from the hardware component the first time, and then periodically, based on this timer function. Note that operations 403-305 may be executed multiple times prior to operation 406, which is a stop_capture command from the application. The collected data may then be placed in a predetermined area of memory, for use by the application.

Once the raw data has been collected in this manner, the application may apply certain algorithms or other techniques for analyzing the data to derive the characterization data, including, for example, thermal relationships between components and relationships between the temperature of a component and the rate of data traffic through that component. In one instance, the derived characterization data is stored as part of the ACPI name space which is accessible by all drivers.

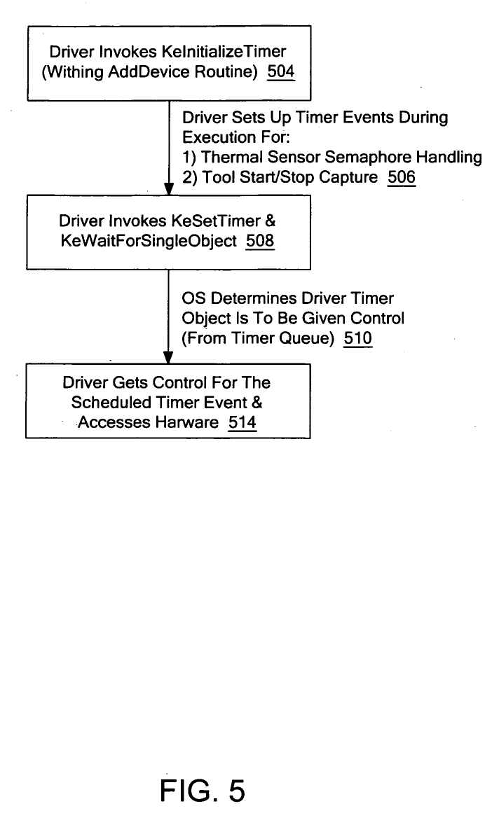

FIG. 5 is a flow chart indicating a timer-based technique for collecting data by a driver, according to an embodiment of the invention. Operation begins with the driver invoking a well known Microsoft™ Windows API, KeInitializedTimer (within the AddDevice routine). This allows the driver to set up timer events during execution for thermal sensor semaphore handling, and the start/stop capture abilities of the overall thermal collection and management tool of which the driver and application may be a part (operation 506). Once initialized, the driver may invoke another well known Windows API, KeSetTimer and KeWaitForSingleObject (operation 508) which starts the timer function of the operating system. The operating system determines which of its driver timer objects is to be given control, from its timer queue (operation 510). At that point, the driver is given control for the scheduled timer event, and may then access the hardware to, for example, read a register value (operation 514). Operations 508 and 514 may be continuously repeated by the driver, until, for example, a stop_capture command is received from the application layer.

An embodiment of the invention is a machine readable medium having stored thereon instructions which program one or more processors to perform some of the operations described above, e.g. dynamic, thermal management by a driver. In other embodiments, some of these operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), magnetic rotating disks, and a transmission over the Internet.

The invention is not limited to the specific embodiments described above. For example, the techniques described in FIGS. 4 and 5 for collecting thermal data using the driver may be modified to implement the timer aspect differently (e.g., using counters implemented in the driver code itself, or counters within the hardware layer). Also, an alternative technique for providing the collected data to the application may be for the driver to receive the address of a buffer area that has been allocated in main memory, by the application, and then the driver writing the collected data to the specified buffer area. Accordingly, other embodiments are within the scope of the claims.

What is claimed is:

1. A method comprising:
a) collecting one of thermal, acoustic and power data about a platform, in a runtime environment;
b) selecting a component of the platform and forcing predetermined data traffic through the component while collecting the data; and
c) deriving characterization data for the platform from the collected data and storing the characterization data for access by a driver for the platform.

2. The method of claim 1 wherein the driver is to access the characterization data for managing one of thermal effects, acoustic effects, and power consumption and manage the thermal, acoustic, or power consumption in a runtime environment at an end user stage, transparently to an end user.

3. The method of claim 2 wherein collecting thermal, acoustic, or power data in the runtime environment is performed at an original equipment manufacturer (OEM) stage.

4. The method of claim of 3 wherein storing the characterization data for access by the driver comprises storing the characterization data in a database in the OEM stage.

5. The method of claim 1 wherein a) and b) are performed upon a system that is based on the platform, at a manufacturer of the system.

6. The method of claim 1 further comprising:
using the derived characterization data by a system manufacturer to compensate for one of thermal, power, and acoustic issues detected in a system that is based on the platform, by one of changing a programmable operating parameter of an integrated circuit component of the platform and changing a physical structure aspect of the system.

7. The method of claim 1 wherein collecting thermal, acoustic, or power data in the runtime environment is performed by running an application program on a system based on the platform at an original equipment manufacturer (OEM) stage, wherein the application program calls said driver to collect the data in the runtime environment and prompts the OEM to select the component and select the predetermined data traffic through the component.

8. An article of manufacture comprising:
a machine-readable medium containing stored instructions that, when executed by a machine, implement a plurality of operating system drivers for different hardware components of a system, each driver to access one of stored, thermal and power characterization data for a platform on which the system is based, and to use the accessed data to keep one of temperature and power consumption in the system under control.

9. The article of manufacture of claim 8 wherein the drivers are for a graphics processing component, a mass storage component, a peripheral I/O controller component, a network interface component, and a main memory component of the platform.

10. The article of manufacture of claim 8 wherein the drivers are for a graphics memory controller hub and I/O controller hub of the platform.

11. The article of manufacture of claim 8 wherein one of the drivers is to one of (1) access a hardware register of an integrated circuit (IC) device of the system to obtain a temperature measurement made by a sensor for the IC device, and (2) receive an alert that a temperature of the IC device has passed a programmed temperature threshold.

12. The article of manufacture of claim 11 wherein said one of the drivers is to use an Advanced Configuration Power Interface (ACPI) to access the hardware register.

13. The article of manufacture of claim 8 wherein the drivers are to program (1) clock throttling values and (2) thermal sensor temperature thresholds, for their respective hardware components.

14. The article of manufacture of claim 8 wherein the drivers are to access stored characterization data that describes one of data traffic-related thermal and power changes in the platform, and to use the accessed data to reduce idle state power consumption in the system.

15. The article of manufacture of claim 8 wherein the drivers are to collect one of thermal, acoustic and power data about a computing platform, in a runtime environment.

16. A system comprising:
a processor;
memory having stored therein instructions to be executed by the processor and that implement a device driver that can collect thermal data about a computing platform on which the system is based, in a runtime environment, and is to automatically access stored, thermal characterization data about the platform to manage one of thermal effects and power consumption in the system; and
a rechargeable power source coupled to power the processor and memory.

17. The system of claim 16 wherein the driver is to use the accessed characterization data to change operating parameters of the system in a runtime environment without requiring input from a user of the system.

18. The system of claim 16 wherein the instructions implement a further operating system driver that can collect thermal data about another component of the platform, and is to automatically access the stored, thermal characterization data to manage one of further thermal effects and further power consumption in the system.

19. The system of claim 16 wherein the driver is to collect data by invoking a timer function of an operating system kernel and periodically reading a hardware register of a component of the platform based on the timer function.

20. An article of manufacture comprising:
a machine-accessible medium containing instructions that when executed cause an application program to invoke a driver interface routine that starts capture, in a runtime environment, of one of thermal and power data about a component of a system,
invoke an operating system programming interface routine to induce controlled data traffic through said component, to stress the component from one of a power and thermal standpoint while the data is captured, and
derive one of thermal and power characterization data for the component from the captured data.

21. The article of manufacture of claim 20 wherein the medium contains further instructions that when executed cause the application program to invoke a driver interface routine that stops the capture of the thermal or power data.

22. The article of manufacture of claim 20 wherein the medium contains further instructions that when executed cause the application program to display the derived characterization data to a manufacturer of the system and provide suggestions to the manufacturer for modifying a design of the system based on the displayed data.

23. The article of manufacture of claim 20 wherein the characterization data informs about power utilization in the system, as derived from the amount of data traffic through the component without relying on a direct power measurement.

24. The article of manufacture of claim 20 wherein the characterization data comprises a thermal relationship table that predicts how a temperature of a component of the system changes as a function of a temperature or activity of another component of the system.

25. The article of manufacture of claim 20 wherein the application program is to generate a graph that depicts thermal relationships among components of the system.

26. The article of manufacture of claim 20 wherein the application program is to make one or more operating system API calls that induce controlled data traffic through one and not others of a) a peripheral I/O controller, b) a main memory controller, c) a storage controller, d) a display controller, and e) a network interface controller.
